(19) United States
(12) Patent Application Publication
(10) Pub. No.: US 2011/0155760 A1
(43) Pub. Date: Jun. 30, 2011

(54) One handed article dispenser

(76) Inventors: Christina Wulfson, Los Angeles, CA (US); Alex Hulsey, Los Angeles, CA (US)

(21) Appl. No.: 12/930,219

(22) Filed: Dec. 29, 2010

Related U.S. Application Data
(60) Provisional application No. 61/335,135, filed on Dec. 31, 2009.

(51) Int. Cl. B67D 7/06

(52) U.S. Cl. 222/81

(57) ABSTRACT

This invention relates to a storage device of articles that allows a user to dispense the articles from the device using only one hand. This device can be used to dispense single articles or a combination of articles that are stored separately within the device. This device may used to dispense, either singularly or in combination, condiments such as sugar, cream, salt, pepper, ketchup, mustard, duck sauce, soy sauce and cream cheese, etc. This device may also be used to separately house items that require separate storage and dispensing and mixing at the time of use such as co-polymers for the mixing of resins and glues, etc.

### BACKGROUND ART

In this increasingly fast paced world, many people are multitasking and are often partaking of refreshment “on the run.” In this environment the industry has responded by packaging various condiments in single serving containers, e.g. sugar, cream, salt, pepper, ketchup, mustard, duck sauce, soy sauce and cream cheese, etc. These packages are most often made of a paper product, however composites of paper and plastic, aluminum foil or other suitable materials are used as well.

While such packaging has had incredible benefits it does have significant drawbacks. These packages are often very difficult to open, even with two hands. Many times while opening these packages the contents, or a portion of them, are spilled. Sometimes that spillage ends up on the user's garment or the upholstery of their vehicle, perhaps even leaving a permanent stain. In some instances the user has struggled so hard to open such a package that when it does finally open, so much force was being exerted that as it opens the hands also break free unexpectedly and spill or upset the article to which the contents of the package were being applied. This is even a more upsetting result, since often times such a user may be miles from where they purchased the article, and not able to return to replace it. When that is a portion of their meal perhaps, this is very upsetting.

This form of single portion packaging is essentially a sealed cup, bag or pouch that requires two hands to open them, most often utilizing a tearing motion to remove the seal or tear open the package. This then generates in most situations two separate articles of trash, the torn or removed portion and the remainder of the package that once contained the article dispensed.

There is a long felt need for a packaging device that easily permits a user to dispense an article with one hand. Our invention disclosed herein fills that need. By placing an internal container within an external container that is open at opposite ends such that a sealed end of the internal container protrudes from one open end of the external container and the opposite end of the internal container forms a puncturing means and also forms an open end of the internal container into which a desired article may be stored and sealed in place by placing a seal on the end of the external container opposite the protruding end of the internal container, then when a user wishes to dispense the article sealed in the container they may easily hold the device in one hand and with their thumb or finger merely press on the protruding portion of the inner container which then slides through the external container thereby piercing with the puncturing means the seal on the opposite end from the end being pushed and thus releasing the article. The device may then be used as an applicator or stirrer to manipulate the dispensed article according to the needs of the user, thus eliminating the need for yet another item (e.g. stirrer or spreader) which would then require disposal as well.

There is a growing need for such a novel device. As consumer's lives become increasingly hectic such labor saving devices will be more and more in demand. Over the past twenty years in the United States alone there has been an exponential growth in convenience stores selling single serving items from coffee to sandwiches and the dispensing means of choice for the accompanying condiments is almost always single portion packaging. A convenient one handed dispenser will fill that need.

There are no acceptable prior art one handed article dispenser devices that eliminate the need of using both hands to open them. While each prior packaging device may fulfill their respective particular objectives and requirements, and are most likely quite functional for their intended purposes, it will be noticed that none of the prior art cited disclose an apparatus that permits a user to easily open a package with one hand without generating an additional article of trash. Nor is there an easy to open with one hand storage device that contains multiple articles stored separately that can then be dispensed at the same time. As such, there apparently still exists the need for new and improved one handed article dispenser device to maximize the benefits to the user and minimize difficulties from its use. The current invention addresses all of these issues to provide a technology that provides a much more effective, efficient and user friendly device.

In this respect, the present invention disclosed herein substantially corrects these problems and fulfills the need for such a device.

### DISCLOSURE OF THE INVENTION

In view of the foregoing limitations inherent in the known types of single portion packaging devices now present in the prior art, the present invention provides an apparatus that has been designed to provide the following features for a user:
An inexpensive dispenser that is easily stored and packaged in bulk.
Easy opening with one hand.
Minimizes the generation of additional articles needing disposal after use.
Minimizes spillage and waste of the packaged article allowing for relatively precise delivery of the article to its intended location using one hand to dispense and one hand if needed to control the receiving means of the dispensed article.
Once the article is dispensed the device itself may be used as an applicator or stirrer to manipulate the dispensed article in a user desired manner.
Multiple article dispensing by storing one or more articles in the device.

These features are improvements which are patently distinct over similar devices and methods which may already be patented or commercially available. As such, the general purpose of the present invention, which will be described subsequently in greater detail, is to provide a field designed apparatus that incorporates the present invention. There are many additional novel features directed to solving problems not addressed in the prior art.

In the preferred embodiment disclosed herein and as more particularly illustrated on the attached drawings, an internal container is placed within an external container that is open at opposite ends such that a sealed end of the internal container protrudes from one open end of the external container and the opposite end of the internal container forms a puncturing means and also forms an open end of the internal container into which a desired article may be stored and sealed in place by placing a seal on the end of the external container opposite the protruding end of the internal container, then when a user wishes to dispense the article sealed in the container they may easily hold the device in one hand and with their thumb press on the protruding portion of the inner container which then slides through the external container thereby piercing with the puncturing means the seal on the opposite end from the end being pushed and thus releasing the article. The device may then be used as an applicator or stirrer to manipulate the dispensed article according to the needs of the user, thus eliminating the need for yet another item (e.g. stirrer or spreader) which would then require disposal as well.

It would be obvious to one skilled in the art to construct this device in different shapes and sizes. Similarly it would be obvious to manufacture this device out of some other material like that of plastic, metal, ceramic or composite. Also, it would be obvious to use this device for virtually any article desired to be dispensed in this manner from toothpaste to glue, from paint to cereal. Similarly, this device can be used to store separately, but dispense together multiple items such as cream and sugar, salt and pepper, the components of polymers used in glues or other resins that need to be mixed at the time of dispensing or other articles a user may want to combine simultaneously or in sequence at the time of dispensing from such a packaging means as disclosed in our invention.

To attain this, the present invention generally comprises four major components: 1) at least one Internal Container; 2) at least one External Container; 3) a Sealing Means; and 4) a Puncturing Means.

These together with other objects of the invention, along with the various features of novelty which characterize the invention, will be pointed out with particularity in the claims which will be annexed to and forming a part of the full patent application once filed. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is perspective view of the single article dispenser embodiment of the One Handed Article Dispenser device in the sealed condition prior to dispensing the contained article.

FIG. 1A is perspective view of the single article dispenser embodiment of the One Handed Article Dispenser device in the open condition during the dispensing of the contained article.

FIG. 2 is perspective view of the multiple article dispenser embodiment of the One Handed Article Dispenser device in the sealed condition prior to dispensing the contained articles.

FIG. 2A is perspective view of the multiple article dispenser embodiment of the One Handed Article Dispenser device in the open condition during the dispensing of the contained articles.

### BEST MODES FOR CARRYING OUT THE INVENTION

### I. Preferred Embodiments

A. Single Article Dispenser Embodiment

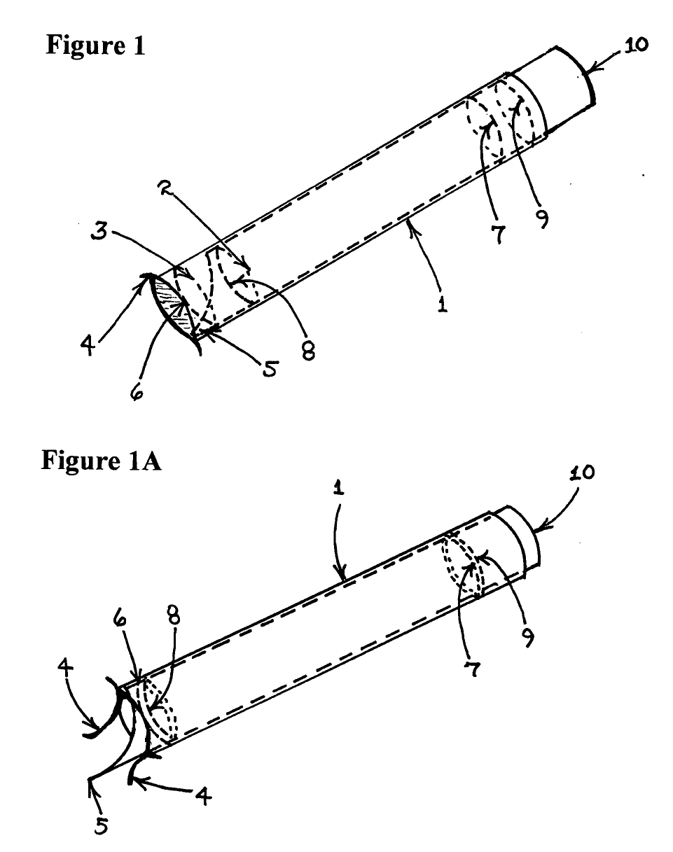

With reference now to the drawings, and in particular to FIGS. 1-1A thereof, a new and novel single article embodiment of the One Handed Article Dispenser Device (1) embodying the principles and concepts of the present invention is depicted in these drawings as comprising four major components, at least one Internal Container (2), at least one External Container (3) a Sealing Means (4) and a Puncturing Means (5).

### General Description of Reference Numerals in the Description and Drawings

Any actual dimensions listed are those of the preferred embodiment. Actual dimensions or exact hardware details and means may vary in a final product or most preferred embodiment and should be considered means for so as not to narrow the claims of the patent.

### List and Description of Component Parts of the Invention:

(1) One Handed Article Dispenser Device
(2) Internal Container
(3) External Container
(4) Sealing Means
(5) Puncturing Means
(6) External Container Distal End Ring Stop
(7) External Container Medial Ring Stop
(8) Internal Container Distal End Ring Stop
(9) Internal Container Medial Ring Stop
(10) Internal Container Sealed End

In the single article dispenser preferred embodiment the One Handed Article Dispenser Device (1) is made of a semi-rigid to a rigid material such as extruded plastic straws from molten plastic composition or other similar material as a user prefers. The One Handed Article Dispenser Device (1) is comprised of an Internal Container (2) made of a semi-rigid to a rigid material formed in the shape of a container capable of holding an article for future dispensing. The Internal Container (2) is further comprised of; an Internal Container Sealed End (10); a Puncturing Means (5) disposed at the opposite of the Internal Container (2) from the Internal Container Sealed End (10) which forms the opening into and out of which articles for dispensing will pass; and on the outside surface is disposed an Internal Container Distal End Ring Stop (8), and an Internal Container Medial Ring Stop (9). The One Handed Article Dispenser Device (1) is further comprised of an External Container (3) made of a semi-rigid to a rigid material formed open at both ends and formed in a shape and size capable of having the Internal Container (2) pass through the External Container (3). The External Container (3) is further comprised of; an External Container Distal End Ring Stop (6) and an External Container Medial Ring Stop (7), both of which are disposed on the internal surface of the External Container (3).

The outside diameter or outside dimensions if not circular in shape of the Internal Container (2) is formed such that it is slightly less than the inside diameter or inside dimensions if not circular in shape of the External Container (3). The Internal Container Distal End Ring Stop (8), and the Internal Container Medial Ring Stop (9), are formed such that the outside diameter or the outside dimensions if not circular in shape are equal to or slightly larger than the inside diameter or inside dimensions if not circular in shape of the External Container (3) thereby forming a fluid tight seal when the Internal Container (2) is operatively disposed within the External Container (3). Similarly the External Container Distal End Ring Stop (6), and the External Container Medial Ring Stop (7) are formed such that the outside diameter or the outside dimensions if not circular in shape are equal to or slightly larger than the outside diameter or outside dimensions if not circular in shape of the Internal Container (2) thereby forming a fluid tight seal when the Internal Container (2) is operatively disposed within the External Container (3).

The Internal Container (2) is made of a length that is longer than the External Container (3) such that when the Internal Container (2) is operatively disposed within the External Container (3) in storage mode, the Internal Container Sealed End (10) will protrude from one of the open ends of the External Container (3) whereas the Puncturing Means (5) of the Internal Container (2) will be entirely disposed within the External Container (3) but juxtaposed next to opposite open end of the External Container (3). The External Container Distal End Ring Stop (6) is located at or near the open end of the External Container (3) where the Internal Container Sealed End (10) protrudes. The longitudinal distance between the Internal Container Distal End Ring Stop (8), and the Internal Container Medial Ring Stop (9) is slightly less than the longitudinal distance between the External Container Distal End Ring Stop (6), and the External Container Medial Ring Stop (7) such that in the storage mode the series of ring stops prevent the movement of the Internal Container (2) separate from the External Container (3) with the user desired dispensing force being applied against the protruding Internal Container Sealed End (10).

Once assembled in the storage mode the user desired article is placed and contained within the Internal Container (2) and sealed therein by the Sealing Means (4) which is attached to and completely seals off the open end of the External Container (3) that lies opposite the open end of the External Container (3) where the Internal Container Sealed End (10) protrudes. The One Handed Article Dispenser Device (1) is then ready for dispensing the contained article. The user simply grasps the External Container (3) portion of the One Handed Article Dispenser Device (1) in one hand and with any desired finger or thumb of the same hand depresses the Internal Container Sealed End (10) that protrudes from the External Container (3) thereby forcing the Internal Container (2) to move therein and forcing the Internal Container Medial Ring Stop (9) to pass over the External Container Medial Ring Stop (7) in the direction of the desired dispensing and by so doing the Puncturing Means (5) punctures the Sealing Means (4) releasing the stored article to a user desired location.

B. Multiple Article Dispenser Embodiment

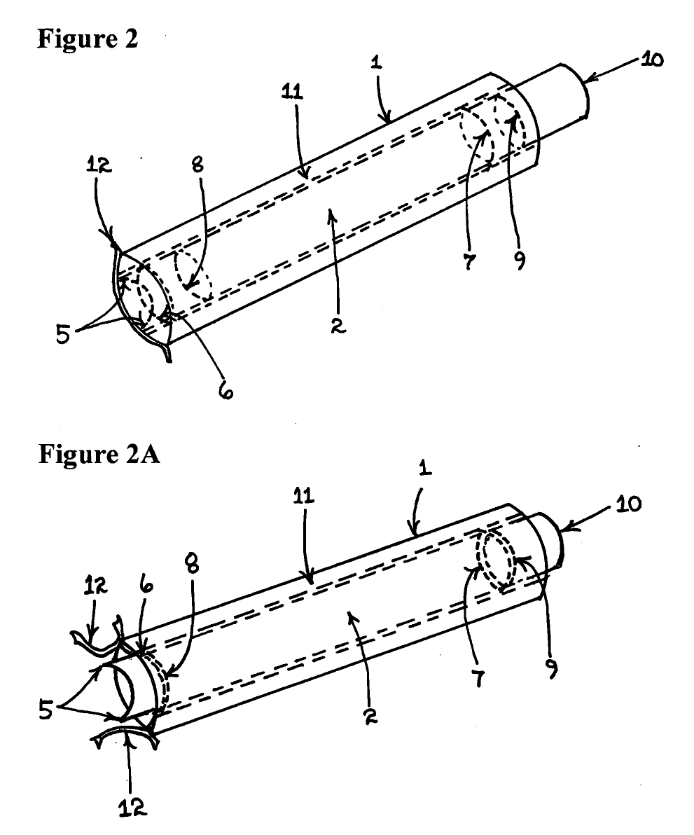

With reference now to the drawings, and in particular to FIGS. 2-2A thereof, a new and novel multiple article embodiment of the One Handed Article Dispenser Device (1) embodying the principles and concepts of the present invention is depicted in these drawings as comprising four major components, at least one Internal Container (2), at least one External Container (3) a Sealing Means (4) and a Puncturing Means (5).

### General Description of Reference Numerals in the Description and Drawings

Any actual dimensions listed are those of the preferred embodiment. Actual dimensions or exact hardware details and means may vary in a final product or most preferred embodiment and should be considered means for so as not to narrow the claims of the patent.

### List and Description of Component Parts of the Invention:

(1) One Handed Article Dispenser Device
(2) Internal Container
(11) Multi Chamber External Container
(12) Multi Chamber Sealing Means
(5) Puncturing Means
(6) External Container Distal End Ring Stop
(7) External Container Medial Ring Stop
(8) Internal Container Distal End Ring Stop
(9) Internal Container Medial Ring Stop
(10) Internal Container Sealed End

In the multiple article dispenser preferred embodiment the One Handed Article Dispenser Device (1) is made of a semi-rigid to a rigid material such as extruded plastic straws from molten plastic composition or other similar material as a user prefers. The assembly and use of the multiple article dispenser is for all intents and purposes identical to the single article dispenser with the exception that the external container is a Multi Chamber External Container (11) which has one or more separate storage compartments capable of storing for later dispensing, articles that are separated from the articles stored in the Internal Container (2). The Multi Chamber External Container (11) is formed to incorporate an internally housed and rigidly attached structure similar to the External Container (3) used in the single article dispenser embodiment, and thereby creating one or more structures surrounding this internal structure that can each store a user desired article for future dispensing and these outer compartments are sealed at one end and open at the other end for filling until sealed by the Multi Chamber Sealing Means (12). The Multi Chamber Sealing Means (12) is engineered such that when it is pierced by the Puncturing Means (5) it releases the articles in all of the chambers of the device including the Internal Container (2) and the Multi Chamber External Container (11).

Once the multiple article dispenser embodiment is assembled in the storage mode the user desired articles are placed and contained within the Internal Container (2) and the Multi Chamber External Container (11) and then they are sealed therein by the Multi Chamber Sealing Means (12) which is attached to and completely seals off the open end of the Multi Chamber External Container (11) that lies opposite the open end of the Multi Chamber External Container (11) where the Internal Container Sealed End (10) protrudes. The One Handed Article Dispenser Device (1) is then ready for dispensing the contained articles. The user simply grasps the Multi Chamber External Container (11) portion of the One Handed Article Dispenser Device (1) in one hand and with any desired finger or thumb of the same hand depresses the Internal Container Sealed End (10) that protrudes from the Multi Chamber External Container (11) thereby forcing the Internal Container (2) to move therein and forcing the Internal Container Medial Ring Stop (9) to pass over the External Container Medial Ring Stop (7) in the direction of the desired dispensing and by so doing the Puncturing Means (5) punctures the Multi Chamber Sealing Means (12) releasing all the stored articles to a user desired location.

In the use of this invention for food condiments, the device can also be used as a stirrer, mixer or applicator, and can be formed in various configurations to facilitate such a use. Similarly, in the mixing of resins and glues that require that copolymers be mixed upon dispensing the precise quantities necessary of each substrate can be insured by forming the internal and external containers to hold these amounts certain and then the device itself can be used to further mix the dispensed components, however many that may be.

It would be obvious to one skilled in the art to manufacture our invention out of any other suitable material such as plastic, metal, ceramic or other composite material. Similarly, our invention can be designed to store and dispense virtually any article or combination of articles a user may desire, depending upon what articles or combination thereof would require storage and dispensing.

While our above descriptions of the invention, its parts, and operations contains many specificities, these should not be construed as limitations on the scope of the invention, but rather as exemplifications of present embodiments thereof. Many other variations are possible, for example, other embodiments, shapes, and sizes of the device can be constructed and designed to work by the principles of the present invention; various materials, colors and configurations can be employed in the device's design that would provide interesting embodiment differences to users. Similarly this invention can be used to dispense any number of different articles at the same time where a user desires multiple articles to be dispensed.

Accordingly, the scope of the invention should be determined not by the embodiments illustrated, but by the claims and their legal equivalents which accompany this application.

Having described our invention, we claim:

1. A one handed article dispenser comprised of:
an external containment vessel;
the external containment vessel having a sealable dispensing end, an open end, an exterior surface and an interior surface;
an internal end seal attached to the interior surface adjacent to the open end;
a dispensing end seal attached to and sealing the dispensing end of the external containment vessel;
an internal containment vessel;
the internal containment vessel having a penetrating end, a pushing end, an external surface and an internal surface wherein the internal containment vessel is of a size and shape such that when the internal containment vessel is placed inside the external containment vessel with a user selected article contained in said internal containment vessel, the penetrating end is disposed adjacent to the dispensing end seal, the pushing end protrudes out of the open end of the external containment vessel, and the user selected article is maintained within the one handed article dispenser by the dispensing end seal and the internal end seal of the external containment vessel, wherein the internal end seal forms a seal against the external surface of the internal containment vessel; and
the penetrating end of the internal containment vessel is capable of penetrating the dispensing end seal of the external containment vessel when a user pushes the protruding pushing end of the internal containment vessel thereby forcing the penetrating end through the dispensing end seal thereby permitting the user selected article to escape from the one handed article dispenser through the penetrating end and the sealable dispensing end of the external containment vessel.

2. A one handed article dispenser comprised of:
an external containment vessel;
the external containment vessel having at least one article chamber, a sealable dispensing end, an open end, an exterior surface and an interior surface;
an internal end seal attached to the interior surface adjacent to the open end;
a dispensing end seal attached to and sealing the dispensing end of the external containment vessel and containing a user selected article in the article chamber;
an internal containment vessel;
the internal containment vessel having a penetrating end, a pushing end, an external surface and an internal surface wherein the internal containment vessel is of a size and shape such that when the internal containment vessel is placed inside the external containment vessel with an additional user selected article contained in said internal containment vessel, the penetrating end is disposed adjacent to the dispensing end seal, the pushing end protrudes out of the open end of the external containment vessel, and the additional user selected article is maintained within the one handed article dispenser by the dispensing end seal and the internal end seal of the external containment vessel, wherein the internal end seal forms a seal against the external surface of the internal containment vessel; and
the penetrating end of the internal containment vessel is capable of penetrating the dispensing end seal of the external containment vessel when a user pushes the protruding pushing end of the internal containment vessel thereby forcing the penetrating end through the dispensing end seal thereby permitting the user selected article in the article chamber and the additional user selected article to escape from the one handed article dispenser through the penetrating end and the sealable dispensing end of the external containment vessel.

3. The one handed article dispenser of claim 1 wherein the internal end seal is attached to the external surface of the internal containment vessel.

4. The one handed article dispenser of claim 2 wherein the internal end seal is attached to the external surface of the internal containment vessel.

5. The one handed article dispenser of claim 1 wherein the user selected article is selected from a group consisting of dairy products, sugar, honey, artificial sweeteners, condiments, mustards, ketchups, relishes, salsas, spices, salt, pepper, soups, teas, coffees, liquor, icings, toppings, confections, adhesives, co-polymers, medicines or chemicals.

6. The one handed article dispenser of claim 2 wherein the user selected article and the additional user selected article are selected from a group consisting of dairy products, sugar, honey, artificial sweeteners, condiments, mustards, ketchups, relishes, salsas, spices, salt, pepper, soups, teas, coffees, liquor, icings, toppings, confections, adhesives, co-polymers, medicines or chemicals.
